(19) United States
(12) Patent Application Publication
(10) Pub. No.: US 2026/0087777 A1
(43) Pub. Date: Mar. 26, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventors: Takaya Miyamoto, Tokyo (JP); Akinori Ebihara, Tokyo (JP); Taiki Miyagawa, Tokyo (JP)

(73) Assignee: NEC Corporation, Tokyo (JP)

(21) Appl. No.: 19/326,803

(22) Filed: Sep. 12, 2025

(30) Foreign Application Priority Data
Sep. 20, 2024 (JP) 2024-164037

(51) Int. Cl. G06V 10/764; G06V 10/44; G06V 10/74; G06V 10/82

(52) U.S. Cl. CPC G06V 10/764; G06V 10/44; G06V 10/761; G06V 10/82

(57) ABSTRACT

An information processing apparatus includes, an acquisition unit that acquires time-series image data, an index calculation unit that calculates an integrated feature quantity or a score, a first likelihood ratio calculation unit that calculates N first likelihood ratios, each indicating a likelihood that the time-series image data belong to respective one of N registered classes, a second likelihood ratio calculation unit that calculates a second likelihood ratio indicating a likelihood that the time-series image data belong to an unregistered class in a case where the time-series image data are not registered in advance, and a determination unit that determines that the time-series image data belong to the registered class in a case where the first likelihood ratio reaches a predetermined threshold, and determines that the time-series image data do not belong to any registered class in a case where the second likelihood ratio reaches the predetermined threshold.

### INCORPORATION BY REFERENCE

This application is based upon and claims the benefit of priority from Japanese Patent Application No. 2024-164037, filed on Sep. 20, 2024, the disclosure of which is incorporated herein in its entirety by reference.

### TECHNICAL FIELD

Example embodiments of a present disclosure relate to an information processing apparatus, an information processing method, and a non-transitory recording medium.

### BACKGROUND ART

A known apparatus of this type performs processing of determining a class to which data belong (so-called class classification). For example, International Publication No. WO2021/229663 discloses a technology/technique of determining a class to which series data serving as a classification target belong, in a case where an individual score or an integrated score calculated based on a likelihood ratio reaches a predetermined threshold.

### SUMMARY

It is an example object of the present disclosure to provide an information processing apparatus, an information processing method, and a non-transitory recording medium for improving the technology disclosed in the background art.

An information processing apparatus according to an example aspect of the present disclosure includes: an acquisition unit that acquires time-series image data; an index calculation unit that calculates an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; a first likelihood ratio calculation unit that calculates N first likelihood ratios, each indicating a likelihood that the time-series image data belong to respective one of N registered classes (where N is a natural number) corresponding to the registered image data, based on the integrated feature quantity or the score; a second likelihood ratio calculation unit that calculates a second likelihood ratio indicating a likelihood that the time-series image data belong to an unregistered class in a case where the time-series image data are not registered in advance, based on the N first likelihood ratios; and a determination unit that determines that the time-series image data belong to the registered class in a case where the first likelihood ratio reaches a predetermined threshold, and determines that the time-series image data do not belong to any registered class in a case where the second likelihood ratio reaches the predetermined threshold.

An information processing method according to an example aspect of the present disclosure is an information processing method that is executed by at least one computer, the information processing including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating N first likelihood ratios, each indicating a likelihood that the time-series image data belong to respective one of N registered classes (where N is a natural number) corresponding to the registered image data, based on the integrated feature quantity or the score; calculating a second likelihood ratio indicating a likelihood that the time-series image data belong to an unregistered class in a case where the time-series image data are not registered in advance, based on the N first likelihood ratios; and determining that the time-series image data belong to the registered class in a case where the first likelihood ratio reaches a predetermined threshold, and determining that the time-series image data do not belong to any registered class in a case where the second likelihood ratio reaches the predetermined threshold.

A non-transitory recording medium according to an example aspect of the present disclosure is a non-transitory recording medium on which a computer program that allows at least one computer to execute an information processing method is recorded, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating N first likelihood ratios, each indicating a likelihood that the time-series image data belong to respective one of N registered classes (where N is a natural number) corresponding to the registered image data, based on the integrated feature quantity or the score; calculating a second likelihood ratio indicating a likelihood that the time-series image data belong to an unregistered class in a case where the time-series image data are not registered in advance, based on the N first likelihood ratios; and determining that the time-series image data belong to the registered class in a case where the first likelihood ratio reaches a predetermined threshold, and determining that the time-series image data do not belong to any registered class in a case where the second likelihood ratio reaches the predetermined threshold.

### BRIEF DESCRIPTION OF THE DRAWINGS

FIG. 1 is a block diagram illustrating a hardware configuration of a first information processing apparatus;

FIG. 2 is a block diagram illustrating a functional configuration of the first information processing apparatus;

FIG. 3 is a flowchart illustrating a flow of operation of the first information processing apparatus.

FIG. 4 is version 1 of a graph illustrating an example of a likelihood ratio calculated by the first information processing apparatus;

FIG. 5 is version 2 of a graph illustrating an example of the likelihood ratio calculated by the first information processing apparatus;

FIG. 6 is a block diagram illustrating a configuration of a likelihood ratio calculation unit in a second information processing apparatus;

FIG. 7 is a block diagram illustrating a configuration of a likelihood ratio calculation unit in a modified example in the second information processing apparatus;

FIG. 8 is a block diagram illustrating a functional configuration of a third information processing apparatus; and

FIG. 9 is a flowchart illustrating a flow of operation of the third information processing apparatus.

### EXAMPLE EMBODIMENTS

Hereinafter, an information processing apparatus, an information processing method, a computer program, and a recording medium according to example embodiments will be described with reference to the drawings.

### First Example Embodiment

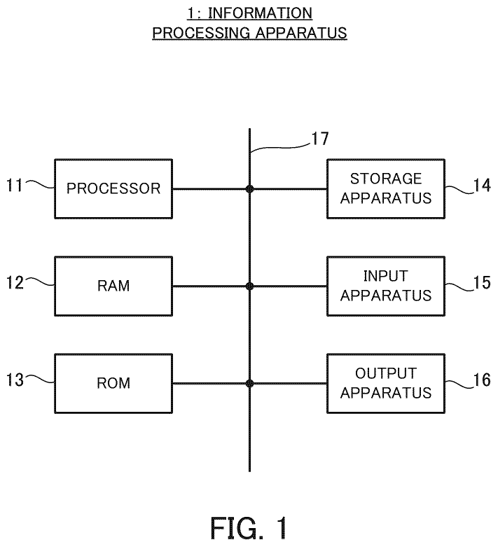

A first information processing apparatus will be described with reference to FIG. 1 to FIG. 5.

### (Hardware Configuration)

First, with reference to FIG. 1, a hardware configuration of the first information processing apparatus will be described. FIG. 1 is a block diagram illustrating the hardware configuration of the first information processing apparatus.

As illustrated in FIG. 1, a first information processing apparatus 1 includes a processor 11, a RAM (Random Access Memory) 12, a ROM (Read Only Memory) 13, a storage apparatus 14, an input apparatus 15, and an output apparatus 16. The processor 11, the RAM 12, the ROM 13, the storage apparatus 14, the input apparatus 15, and the output apparatus 16 described above are connected via a data bus 17. The data bus 17 may be an interface other than a data bus (e.g., a LAN, a USB, etc.).

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may acquire (i.e., read) a computer program from a not-illustrated apparatus disposed outside the first information processing apparatus 1 via a network interface. The processor 11 performs various types of processing by executing the read computer program. When the processor 11 executes the read computer program, a function block related to processing to be performed by the first information processing apparatus 1 is realized in the processor 11. That is, the processor 11 may function as a controller that performs various types of processing and control in the first information processing apparatus 1.

The processor 11 may be configured as, for example, a CPU (Central Processing Unit), a GPU (Graphics Processing Unit), a FPGA (Field-Programmable Gate Array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by processor 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the first information processing apparatus 1 for a long time. The storage apparatus 14 may operate as a transitory storage apparatus of the processor 11. The storage apparatus 14 may store the computer program to be executed by the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the first information processing apparatus 1. The input apparatus 15 may include, for example, at least one of a keyboard, a mouse, a touch panel, and a touch pen. The input apparatus 15 may be an apparatus that allows audio input/voice input, including a microphone, for example.

The output apparatus 16 is an apparatus that outputs information about the first information processing apparatus 1 to the outside. For example, the output apparatus 16 may be a display apparatus (e.g., a display, a monitor, etc.) that is configured to display the information about the first information processing apparatus 1. The output apparatus 16 may also be a speaker that audio-outputs the information about the first information processing apparatus 1, or the like.

The first information processing apparatus may be configured to include only a part of each component described in FIG. 1. For example, the first information processing apparatus 1 may be configured to include only the processor 11, the RAM 12, and the ROM 13 of the above-described components. In this case, each of the storage apparatus 14, the input apparatus 15, and the output apparatus 16 may be provided as an apparatus external to the first information processing apparatus 1. In addition, a part of an arithmetic function of the first information processing apparatus 1 may be realized by an external server, a cloud, or the like.

### (Functional Configuration)

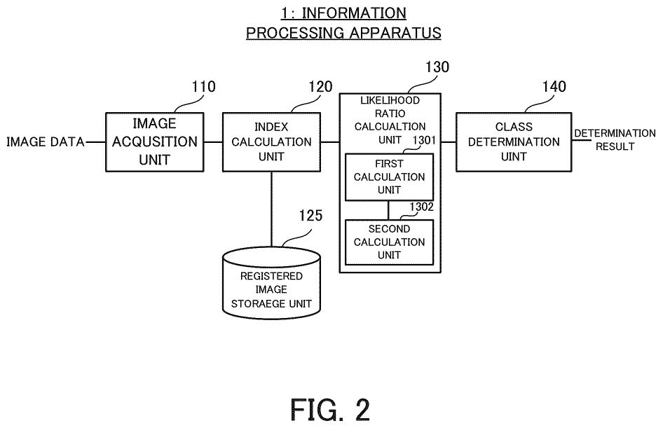

Next, with reference to FIG. 2, a functional configuration of the first information processing apparatus 1 will be described. FIG. 2 is a block diagram illustrating the functional configuration of the first information processing apparatus.

In FIG. 2, the first information processing apparatus 1 is configured as an apparatus that classifies inputted series data. More specifically, the first information processing apparatus 1 is configured to perform matching/verification processing (in other words, authentication processing) of a target included in image data, by classifying inputted time-series image data into a class corresponding to registered image data. The first information processing apparatus 1 includes, as components for realizing its functions, an image acquisition unit 110, an index calculation unit 120, a registered image storage unit 125, a likelihood ratio calculation unit 130, and a class determination unit 140. Each of the image acquisition unit 110, the index calculation unit 120, the likelihood ratio calculation unit 130, and the class determination unit 140 may be a processing block realized by the processor 11 described above (see FIG. 1).

The image acquisition unit 110 is configured to acquire time-series image data. The image acquisition unit 110 may sequentially acquire a plurality of frames of image data. For example, the image acquisition unit 110 may be configured to acquire an image at each frame captured, from a camera that captures a video. The time-series image data acquired by the image acquisition unit 110 are acquired in order to perform the matching processing to registered image data registered in advance. For example, the time-series image data may be face image data including a face of the target. In this case, the acquired face image data may be used to perform face authentication/facial recognition using the face of the target. The face image data are merely an example, and the time-series image data may be image data including a part other than the face of the target (e.g., fingerprints, an iris, etc.). The time-series image data may also include a target other than a person. The time-series image data acquired by the image acquisition unit 110 are outputted to the index calculation unit 120.

The index calculation unit 120 is configured to calculate an integrated feature quantity or a score from the time-series image data acquired by the image acquisition unit 110. The integrated feature quantity is a feature quantity obtained by integrating a first feature quantity that is a feature quantity of the time-series image data and a second feature quantity that is a feature quantity of the registered image data registered in advance. The score indicates a degree of similarity (in other words, a degree of matching) between the first feature quantity and the second feature quantity described above. The index calculation unit 120 may have a function of extracting a feature quantity from the image data in order to calculate the integrated feature quantity or score. For example, the index calculation unit 120 may have a function of extracting a feature quantity of the face of the target from the face image data including the face of the target. The index calculation unit 120 acquires the time-series image data from the image acquisition unit 110, while acquiring the registered image data from the registered image storage unit 125, thereby to calculate the integrated feature quantity or score. The integrated feature quantity or score calculated by the index calculation unit 120 is outputted to the likelihood ratio calculation unit 130.

The registered image storage unit 125 is configured to store the registered image data to be used by the index calculation unit 120 when calculating the integrated feature quantity or score. The registered image storage unit 125 may be configured to store the feature quantity extracted from the registered image data (i.e., the second feature quantity) rather than the registered image data itself. The registered image storage unit 125 may be realized by using the storage apparatus 14 described above (see FIG. 1). Alternatively, the registered image storage unit 125 may be realized by a database or the like provided outside the first information processing apparatus 1. The registered image storage unit 125 is configured to store a plurality of pieces of registered image data. The index calculation unit 120 may calculate N integrated feature quantities or N scores by using the first feature quantity extracted from the time-series image data and N second feature quantities respectively extracted from N pieces of registered image data. The registered image data stored in the registered image storage unit 125 may be, for example, the face image data on a registered user to be used for face authentication/facial recognition. In this case, the integrated feature quantity and the score calculated by the index unit 120 are indices indicating a degree of matching between the face of the target included in the time-series image data and the face of the registered user.

The likelihood ratio calculation unit 130 includes a first calculation unit 1301 and a second calculation unit 1302. The likelihood ratio calculation unit 130 is configured to output a first likelihood ratio calculated by the first calculation unit 1301 and a second likelihood ratio calculated by the second calculation unit 1302 to the class determination unit 140. The first calculation unit 1301 and the second calculation unit 1302 will be described in detail below.

The first calculation unit 1301 is configured to calculate a first likelihood ratio. The first likelihood ratio is a value indicating the likelihood of a class to which the time-series image data belong. Specifically, the first likelihood ratio is a value indicating the likelihood that the time-series image data belong to each of a plurality of registered classes set for respective pieces of registered image data. The first calculation unit 1301 calculates a plurality of likelihood ratios respectively corresponding to the plurality of registered classes (i.e., the same number of likelihood ratios as the number of the registered classes). For example, in a case where N pieces of registered image data are registered in the registered image storage unit 125, N registered classes corresponding to them may be set. In this case, the first calculation unit 1301 calculates N first likelihood ratios respectively corresponding to the N registered classes. A specific method used by the first calculation unit 1301 to calculate the first likelihood ratio is not particularly limited. The first calculation unit 1301 may calculate the first likelihood ratio by using various existing methods. For example, the first calculation unit 1301 may calculate the first likelihood ratio by using an estimation model that is machine-learned in advance (specifically, a neural network learned by deep learning, etc.). The first calculation unit 1301 may calculate the first likelihood ratio based on two or more consecutive pieces of image data of the time-series image data. For example, the first calculation unit 1301 may calculate the first likelihood ratio by using the integrated feature quantity or score calculated from the image data acquired in the past, in addition to the integrated feature quantity or score calculated from the image data acquired immediately before.

The second calculation unit 1302 is configured to calculate a second likelihood ratio. The second likelihood ratio is a value indicating the likelihood that the time-series image data belong to an unregistered class. Here, the unregistered class refers to a class to which the time-series image data belong, in a case where the time-series image data do not belong to any registered class (i.e., in a case where they are unregistered). The second calculation unit 1302 calculates the second likelihood ratio, based on the N first likelihood ratios calculated by the first calculation unit 1301. Even when there are N registered classes, the second calculation unit 1302 may calculate one second likelihood ratio. In this case, the likelihood ratio calculation unit 130 as a whole calculates (N+1) likelihood ratios. A specific method of calculating the second likelihood ratio by the second calculation unit 1302 will be described in detail in another example embodiment later.

The class determination unit 140 is configured to determine the class to which the time-series image data belong, based on the likelihood ratio calculated by the likelihood ratio calculation unit 130. That is, the class determination unit 140 is configured to perform class classification processing based on the likelihood ratio. Specifically, the class determination unit 140 determines that the time-series image data belong to the registered class corresponding to the registered image data in a case where the first likelihood ratio calculated by the first calculation unit 1301 reaches a threshold set in advance. That is, the class determination unit 140 determines that the time-series image data match any one of the pieces of registered image data in a case where the first likelihood ratio reaches the threshold. On the other hand, the class determination unit 140 determines that the time-series image data belong to the unregistered class (in other words, do not belong to any registered class) in a case where the second likelihood ratio calculated by the second calculation unit 1302 reaches the threshold. That is, the class determination unit 140 determines that the time-series image data do not match any one of the pieces of registered image data (in other words, they are unregistered) in a case where the second likelihood ratio reaches the threshold. The threshold used by the class determination unit is a threshold for determining to which class the time-series image data belong, and may be a value set in advance.

### (Flow of Operation)

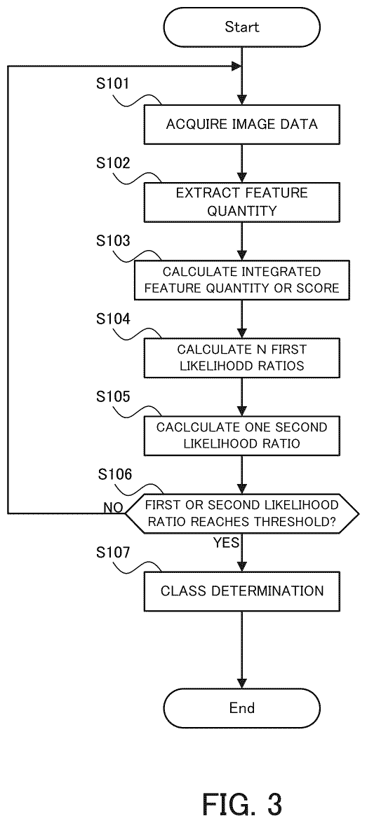

Next, with reference to FIG. 3, a flow of operation of the first information processing apparatus 1 will be described. FIG. 3 is a flowchart illustrating the flow of the operation of the first information processing apparatus.

As illustrated in FIG. 3, when the operation of the first information processing apparatus 1 is started, first, the image acquisition unit 110 acquires the image data (step S101). The image data acquired here may be most recently captured one frame of image data of the time-series image data.

Then, the index calculation unit 120 extracts the first feature quantity from the image data acquired by the image acquisition unit 110 and extracts the second feature quantity from the registered image data read from the registered image storage unit 125 (step S102). Then, the index calculation unit 120 calculates the integrated feature quantity or score, based on the extracted first feature quantity and second feature quantity (step S103).

Then, the first calculation unit 1301 calculates the N first likelihood ratios indicating the likelihood of the registered class to which the time-series image data belong, based on the integrated feature quantity or score calculated by the index calculation unit 120 (step S104). Then, the second calculation unit 1302 calculates the second likelihood ratio, based on the N first likelihood ratios calculated by the first calculation unit 1301 (step S105).

Then, the class determination unit 140 determines whether or not the first likelihood ratio calculated by the first calculation unit 1301 or the second likelihood ratio calculated by the second calculation unit 1302 reaches the threshold (step S106). In a case where the first likelihood ratio or the second likelihood ratio reaches the threshold (step S106: YES), the class determination unit 140 determines to which class the time-series image data belong (step S107).

Specifically, in a case where the first likelihood ratio reaches the threshold, the class determination unit 140 determines that the time-series image data belong to the registered class (i.e., the registered class corresponding to the first likelihood ratio that exceeds the threshold). In this case, it is determined that the time-series image data match the registered image data (in other words, the target is a registered user), and the matching processing is ended. On the other hand, in a case where the second likelihood ratio reaches the threshold, the class determination unit 140 determines that the time-series image data belong to the unregistered class. In this case, it is determined that the time-series image data do not match the registered image data (in other words, the target is an unregistered user), and the matching processing is ended.

On the other hand, in a case where neither the first likelihood ratio nor the second likelihood ratio reaches the threshold (step S106: NO), the processing is started again from the step S101. That is, the image data acquisition unit 110 acquires new image data (e.g., a next frame of image data), and the aforementioned series of processing steps are performed again. By repeating the processing as described above, the first likelihood ratio and the second likelihood ratio calculated by the likelihood ratio calculation unit 130 gradually change. Then, the determination processing (i.e., the matching processing) is continued until the first likelihood ratio or the second likelihood ratio reaches the threshold.

The first information processing apparatus 1 may be configured to perform various types of processing related to the target, based on a determination result of the class determination unit 140. For example, the first information processing apparatus 1 may be configured to perform processing of permitting or prohibiting passage of the target through a predetermined area, based on the determination result of the class determination unit 140. More specifically, in a case where the time-series image data are determined to match the registered image data, the first information processing apparatus 1 may control a gate disposed in a predetermined area to open, thereby permitting the target to pass through. In addition, in a case where it is determined that the time-series image data do not match the registered image data (i.e., they are unregistered), the first information processing apparatus 1 may control the gate disposed in the predetermined area to close, thereby prohibit the target from passing through.

### (Operation Example)

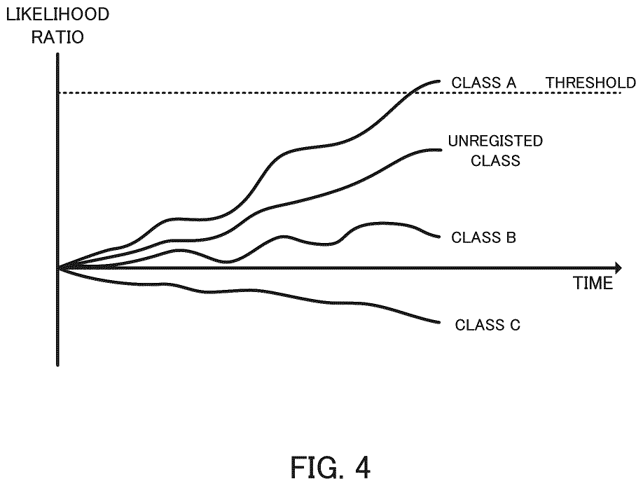

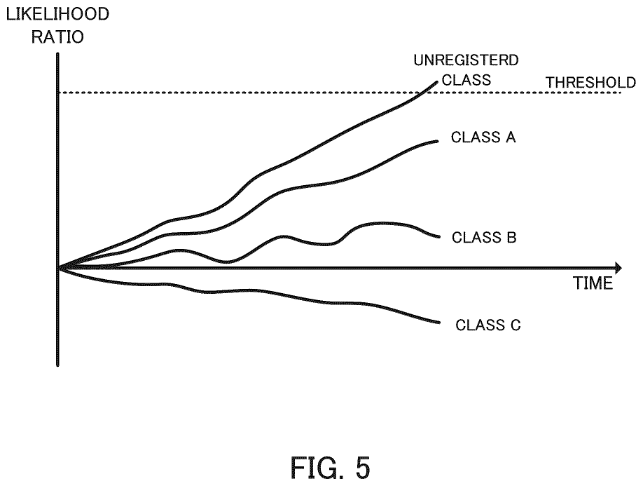

Next, with reference to FIG. 4 and FIG. 5, a specific operation example of the first information processing apparatus 1 (in particular, an example of an operation of determining the class to which time-series image data belong, based on the likelihood ratio) will be described. FIG. 4 is version 1 of a graph illustrating an example of the likelihood ratio calculated by the first information processing apparatus. FIG. 5 is version 2 of a graph illustrating an example of the likelihood ratio calculated by the first information processing apparatus.

In the examples illustrated in FIG. 4 and FIG. 5, registered image data A, registered image data B, and registered image data C are registered as the registered image data. Then, a class A, a class B, and a class C are set as registered classes respectively corresponding to the registered image data A, B, and C. In addition to the registered classes, the unregistered class is also set.

The first calculation unit 1301 calculates respective first likelihood ratios based on the image data acquired by the image acquisition unit 110 and the registered image data A, B, and C. That is, the first calculation unit 1301 calculates a first likelihood ratio corresponding to the class A, a first likelihood ratio corresponding to the class B, and a first likelihood ratio corresponding to the class C. In addition, the second calculation unit 1302 calculates a second likelihood ratio corresponding to the unregistered class, based on the three first likelihood ratios calculated by the first calculation unit 1301. These likelihood ratios gradually change over time (i.e., as the image data are sequentially acquired).

In the example illustrated in FIG. 4, the first likelihood ratio corresponding to the class A reaches the threshold. On the other hand, the first likelihood ratios corresponding to the classes B and C do not reach the threshold. Furthermore, the second likelihood ratio corresponding to the unregistered class does not reach the threshold. In such a case, the time-series image data acquired by the image acquisition unit 110 are determined to belong to the class A. That is, the time-series image data are determined to match the registered image data A and not to match the registered image data B and C. As a result, obtained is such a matching result that the target included in the time-series image data is a user corresponding to the registered image data A.

In the example illustrated in FIG. 5, none of the first likelihood ratios corresponding to the classes A, B, and C reach the threshold. On the other hand, the second likelihood ratio corresponding to the unregistered class reaches the threshold. In such a case, the time-series image data acquired by the image acquisition unit 110 are determined to belong to the unregistered class. In other words, the time-series image data are determined to be unregistered image data that do not belong to any of the classes A, B, and C. Therefore, the time-series image data are determined not to match any one of the registered image data A, B, and C. As a result, obtained is such a matching result that the target included in the time-series image data is an unregistered user.

### (Technical Effect)

Next, a technical effect obtained by the first information processing apparatus 1 will be described.

As described in FIG. 1 to FIG. 5, in the first information processing apparatus 1, it is determined whether the time-series image data are registered based on the first likelihood ratio, while it is determined whether the time-series image data are unregistered based on the second likelihood ratio. In this way, it is possible to reduce a time required for matching/verification in a case where the matching processing to the registered image data is performed by the class classification. For example, if only the first likelihood ratio is used to perform the class classification, the matching result may not be obtained when the first likelihood ratio continues to transition without reaching the threshold. In the present example embodiment, however, the second likelihood ratio corresponding to the unregistered class is also used, and it is therefore possible to obtain such a matching result that the image data are unregistered in a case where the second likelihood ratio reaches the threshold, even if the likelihood ratio does not reach the threshold.

### Second Example Embodiment

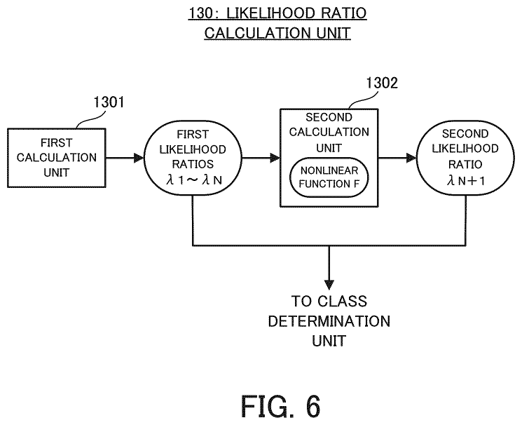

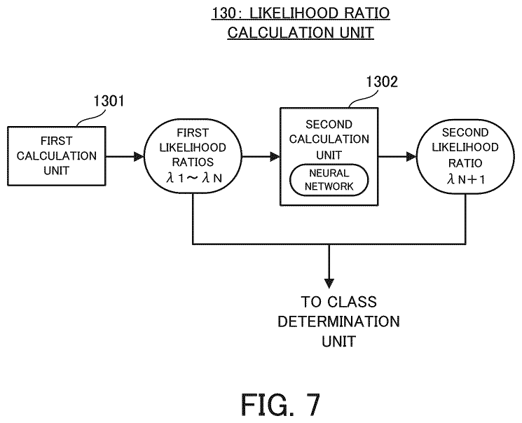

A second information processing apparatus 1 will be described with reference to FIG. 6 and FIG. 7. The second information processing apparatus 1 partially differs from the first information processing apparatus 1 described above in its configuration and operation, and may be the same as the first information processing apparatus 1 in the other parts. For this reason, a part differing from the first example embodiment already described will be described in detail below, and a description of the other overlapping parts will be omitted as appropriate.

### (Likelihood Ratio Calculation Unit)

First, with reference to FIG. 6, a configuration and operation of the likelihood ratio calculation unit 130 in the second information processing apparatus 1 will be described. FIG. 6 is a block diagram illustrating the configuration of the likelihood ratio calculation unit in the second information processing apparatus. In FIG. 6, the same components as those described in FIG. 2 carry the same reference numerals.

In FIG. 6, in the likelihood ratio calculation unit 130 in the second information processing apparatus 1, the first calculation unit 1301 calculates N first likelihood ratios λ1 to λN. In particular, the second calculation unit 1302 calculates one second likelihood ratio λ{N+1} from the N first likelihood ratios λ1 to λN by using a nonlinear function F. The nonlinear function F may use a conditioning parameter p in addition to the first likelihood ratios λ1 to λN. Specific examples of the nonlinear function F may be, for example, the following equations (1) and (2).

$$\begin{matrix}[ Equation 1 ] & \\ λ \{ N + 1 \} = \frac{2 exp ( - α {max}_{i} ( {z}_{i} \cdot {z}_{q} ) )}{exp ( α )} - 1 & ( 1 )\end{matrix}$$

$$\begin{matrix}[ Equation 2 ] & \\ λ \{ N + 1 \} = 2 {( 1 + exp ( \frac{{max}_{i} ( {z}_{i} \cdot {z}_{q} ) - β}{α} ) )}^{- 1} - 1 & ( 2 )\end{matrix}$$

In the above equations (1) and (2), zᵢ is the feature quantity of the registered image data (i.e., the second feature quantity), and z_{q} is the feature quantity of the acquired time-series image data (i.e., the first feature quantity). Furthermore, α and β are parameters whose value ranges are real numbers.

### Modified Example

Next, with reference to FIG. 7, a configuration and operation of the likelihood ratio calculation unit 130 in a modified example in the second information processing apparatus 1 will be described. FIG. 7 is a block diagram illustrating the configuration of the likelihood ratio calculation unit in the modified example in the second information processing apparatus. In FIG. 7, the same components as those described in FIG. 6 carry the same reference numerals are used for.

In FIG. 7, in the likelihood ratio calculation unit 130 in the modified example in the second information processing apparatus 1, the first calculation unit 1301 calculates N first likelihood ratios λ1 to λN. In particular, the second calculation unit 1302 calculates one second likelihood ratio λ{N+1} from the N first likelihood ratios λ1 to λN by using a neural network. The neural network may be an estimation model learned/trained by deep learning. This estimation model may be a model that outputs the second likelihood ratio λ{N+1}, by using the first likelihood ratios λ1 to λN and the conditioning parameter p as inputs.

### (Technical Effect)

Next, a technical effect obtained by the second information processing apparatus 1 will be described.

As described in FIG. 6 and FIG. 7, in the second information processing apparatus 1, the second likelihood ratio is calculated by nonlinear processing using the N first likelihood ratios. In this way, it is possible to appropriately calculate the second likelihood ratio corresponding to the unregistered class. If the second likelihood ratio is calculated by linear processing (e.g., processing of calculating an average/mean value), the processing becomes relatively simple, potentially failing to thoroughly consider each of the N first likelihood ratios. According to the present example embodiment, however, the second likelihood ratio is calculated by the nonlinear processing, and it is therefore possible to calculate the second likelihood ratio after thoroughly considering each of the N first likelihood ratios.

By using the nonlinear function as described in FIG. 6, the second likelihood ratio may be easily and appropriately calculated. In addition, by using the neural network as described in FIG. 7, the second likelihood ratio may be appropriately calculated based on the estimation model learned/trained in advance.

### Third Example Embodiment

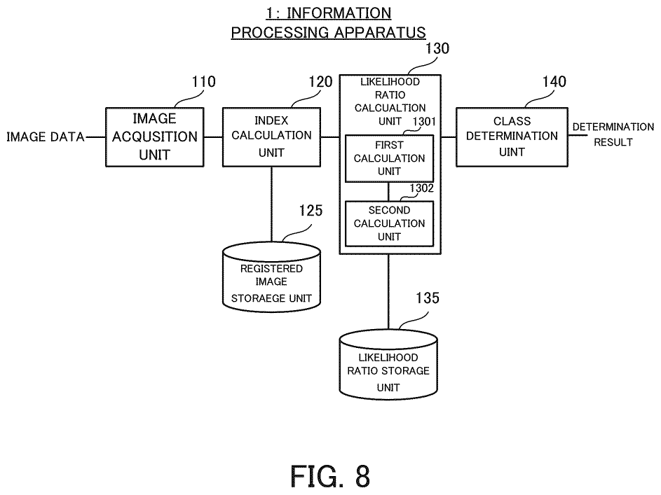

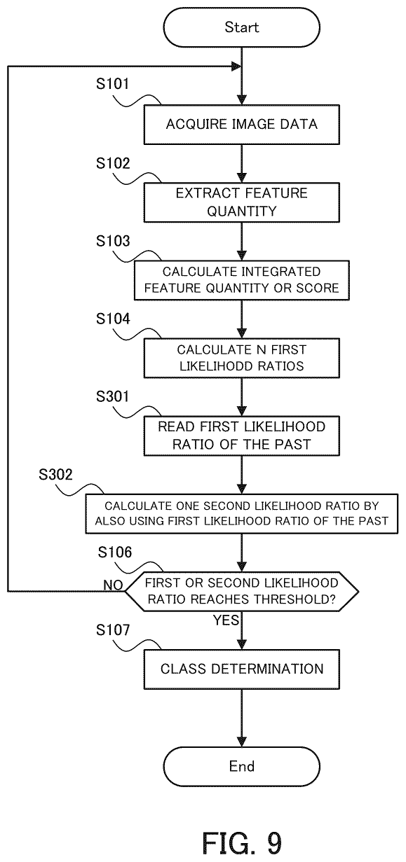

A third information processing apparatus 1 will be described with reference to FIG. 8 and FIG. 9. The third information processing apparatus 1 partially differs from the first and second information processing apparatus 1 described above in its configuration and operation, and may be the same as the first and second information processing apparatus 1 in the other parts. For this reason, a part differing from each of the example embodiments described above will be described in detail below, and a description of the other overlapping parts will be omitted as appropriate.

### (Functional Configuration)

First, with reference to FIG. 8, a functional configuration of the third information processing apparatus 1 will be described. FIG. 8 is a block diagram illustrating the functional configuration of the third information processing apparatus. In FIG. 8, the same reference numerals are used for the same components as those described in FIG. 2.

In FIG. 8, the third information processing apparatus 1 includes, as components for realizing its functions, the image acquisition unit 110, the index calculation unit 120, the registered image storage unit 125, the likelihood ratio calculation unit 130, a likelihood ratio storage unit 135, and the class determination unit 140. That is, the third information processing apparatus 1 further includes the likelihood ratio storage apparatus 135 in addition to the configuration described in the first example embodiment (see FIG. 2).

The likelihood ratio storage apparatus 135 is configured to store the first likelihood ratio calculated by the first calculation apparatus 1301. The likelihood ratio storage apparatus 135 may be realized by using the storage apparatus 14 described above (see FIG. 1). Alternatively, the likelihood ratio storage unit 135 may be realized by a database or the like provided outside the third information processing apparatus 1. The likelihood ratio storage unit 135 may be configured to store the calculated first likelihood ratio at each time when the first likelihood ratio is calculated by the first calculation unit 1301. That is, the likelihood ratio memory unit 135 may be configured to sequentially accumulate the first likelihood ratio calculated by the first calculation unit 1301. The first likelihood ratio stored in the likelihood ratio memory unit 135 is readable by the second calculation unit 1302.

The second calculation unit 1302 in the third information processing apparatus 1 is configured to calculate the second likelihood ratio by using the first likelihood ratio calculated by the first calculation unit 1301 in the past, in addition to the first likelihood ratio most recently calculated by the first calculation unit 1301. Specifically, the second calculation unit 1302 calculates the second likelihood ratio by using the N first likelihood ratios read from the likelihood ratio storage unit 135, in addition to the N first likelihood ratios calculated by the first calculation unit 1301.

### (Flow of Operation)

Next, with reference to FIG. 9, a flow of operation of the third information processing apparatus 1 will be described. FIG. 9 is a flowchart illustrating the flow of the operation of the third information processing apparatus. In FIG. 9, the same steps as those illustrated in FIG. 3 carry the same reference numerals.

As illustrated in FIG. 9, when the operation of the third information processing apparatus 1 is started, first, the image acquisition unit 110 acquires the image data (step S101).

Then, the index calculation unit 120 extracts the first feature quantity from the image data acquired by the image acquisition unit 110 and extracts the second feature quantity from the registered image data read from the registered image storage unit 125 (step S102). Then, the index calculation unit 120 calculates the integrated feature quantity or score, based on the extracted first feature quantity and second feature quantity (step S103).

Then, the first calculation unit 1301 calculates the N first likelihood ratios indicating the likelihood of the registered class to which the time-series image data belong, based on the integrated feature quantity or score calculated by the index calculation unit 120 (step S104).

Then, the second calculation unit 1302 reads N first likelihood ratios calculated in the past, from the likelihood ratio memory 135 (step S301). Then, the second calculation unit 1302 calculates the second likelihood ratio, based on the N first likelihood ratios calculated by the first calculation unit 1301 and the N first likelihood ratios read from the likelihood ratio storage unit 135 (step S302).

Then, the class determination unit 140 determines whether the first likelihood ratio calculated by the first calculation unit 1301 or the second likelihood ratio calculated by the second calculation unit 1302 reaches the threshold (step S106). In a case where the first likelihood ratio or the second likelihood ratio reaches the threshold (step S106: YES), the class determination unit 140 determines to which class the time-series image data belong (step S107).

### (Technical Effect)

Next, a technical effect obtained by the third information processing apparatus 1 will be described.

As described in FIG. 8 and FIG. 9, in the third information processing apparatus 1, the second likelihood ratio is calculated by using the first likelihood ratio calculated in the past, in addition to the most recently calculated first likelihood ratio. In this way, the second likelihood ratio is calculated by taking into account the first likelihood ratio of the past, and it is therefore possible to calculate the second likelihood ratio more appropriately than in a case of using only the most recently calculated first likelihood ratio. For example, it is possible to take into account information such as how high or low the first likelihood ratio of the past is, or whether a slope of the first likelihood ratio of the past is steep or gentle. Therefore, it is possible to more appropriately determine whether or not the time-series image data belong to the unregistered class, based on the second likelihood ratio.

In the above example, described is a case of using the N first likelihood ratios corresponding to one frame of image data of the past, but it is also possible to use the first likelihood ratios corresponding to a plurality of frames of image data of the past. For example, the second calculation unit 1302 may calculate one second likelihood ratio, by using, in addition to N first likelihood ratios corresponding to a first frame of image data most recently calculated, N first likelihood ratios corresponding to a second frame of image data of the past and N first likelihood ratios corresponding to a third frame of image data of the past.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### SUPPLEMENTARY NOTES

The example embodiments described above may be further described as, but not limited to, the following Supplementary Notes below.

### Supplementary Note 1

An information processing apparatus according to Supplementary Note 1 is an information processing apparatus including: an acquisition unit that acquires time-series image data; an index calculation unit that calculates an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; a first likelihood ratio calculation unit that calculates N first likelihood ratios, each indicating a likelihood that the time-series image data belong to respective one of N registered classes (where N is a natural number) corresponding to the registered image data, based on the integrated feature quantity or the score; a second likelihood ratio calculation unit that calculates a second likelihood ratio indicating a likelihood that the time-series image data belong to an unregistered class in a case where the time-series image data are not registered in advance, based on the N first likelihood ratios; and a determination unit that determines that the time-series image data belong to the registered class in a case where the first likelihood ratio reaches a predetermined threshold, and determines that the time-series image data do not belong to any registered class in a case where the second likelihood ratio reaches the predetermined threshold.

### Supplementary Note 2

An information processing apparatus according to Supplementary Note 2 is the information processing apparatus according to Supplementary Note 1, wherein the second likelihood ratio calculation unit calculates the second likelihood ratio by nonlinear processing using the N first likelihood ratios.

### Supplementary Note 3

An information processing apparatus according to Supplementary Note 3 is the information processing apparatus according to Supplementary Note 2, wherein the nonlinear processing uses a nonlinear function.

### Supplementary Note 4

An information processing apparatus according to Supplementary Note 4 is the information processing apparatus according to Supplementary Note 2, wherein the nonlinear processing uses a neural network.

### Supplementary Note 5

An information processing apparatus according to Supplementary Note 5 is the information processing apparatus according to any one of Supplementary Notes 1 to 4, wherein the second likelihood ratio calculation unit calculates the second likelihood ratio, based on the N first likelihood ratios calculated from a first frame of the time-series image data, and the N first likelihood ratios calculated from a second frame that is acquired before the first frame.

### Supplementary Note 6

An information processing method according to Supplementary Note 6 is an information processing method that is executed by at least one computer, the information processing including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating N first likelihood ratios, each indicating a likelihood that the time-series image data belong to respective one of N registered classes (where N is a natural number) corresponding to the registered image data, based on the integrated feature quantity or the score; calculating a second likelihood ratio indicating a likelihood that the time-series image data belong to an unregistered class in a case where the time-series image data are not registered in advance, based on the N first likelihood ratios; and determining that the time-series image data belong to the registered class in a case where the first likelihood ratio reaches a predetermined threshold, and determining that the time-series image data do not belong to any registered class in a case where the second likelihood ratio reaches the predetermined threshold.

### Supplementary Note 7

A computer program according to Supplementary Note 6 is a computer program that allows at least one computer to execute an information processing method, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating N first likelihood ratios, each indicating a likelihood that the time-series image data belong to respective one of N registered classes (where N is a natural number) corresponding to the registered image data, based on the integrated feature quantity or the score; calculating a second likelihood ratio indicating a likelihood that the time-series image data belong to an unregistered class in a case where the time-series image data are not registered in advance, based on the N first likelihood ratios; and determining that the time-series image data belong to the registered class in a case where the first likelihood ratio reaches a predetermined threshold, and determining that the time-series image data do not belong to any registered class in a case where the second likelihood ratio reaches the predetermined threshold.

### Supplementary Note 8

A non-transitory recording medium according to Supplementary Note 8 is a non-transitory recording medium on which a computer program that allows at least one computer to execute an information processing method is recorded, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating N first likelihood ratios, each indicating a likelihood that the time-series image data belong to respective one of N registered classes (where N is a natural number) corresponding to the registered image data, based on the integrated feature quantity or the score; calculating a second likelihood ratio indicating a likelihood that the time-series image data belong to an unregistered class in a case where the time-series image data are not registered in advance, based on the N first likelihood ratios; and determining that the time-series image data belong to the registered class in a case where the first likelihood ratio reaches a predetermined threshold, and determining that the time-series image data do not belong to any registered class in a case where the second likelihood ratio reaches the predetermined threshold.

The present disclosure is not limited to the above-described examples and is allowed to be changed, if desired, without departing from the essence or spirit of the invention which can be read from the claims and the entire specification. An information processing apparatus, an information processing method, a computer program, and a non-transitory recording medium with such changes, are also included in the technical concepts of the present disclosure.

### DESCRIPTION OF REFERENCE NUMERALS

1 Information processing apparatus
11 Processor
12 RAM
13 ROM
14 Storage apparatus
15 Input apparatus
16 Output apparatus
17 Data bus
110 Image acquisition unit
120 Index calculation unit
125 Registered image storage unit
130 Likelihood ratio calculation unit
1301 First calculation unit
1302 Second calculation unit
135 Likelihood ratio memory
140 Class determination unit

What is claimed is:

1. An information processing apparatus comprising:
at least one memory that is configured to store instructions; and
at least one processor that is configured to execute the instructions to:
acquire time-series image data;
calculate an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculate N first likelihood ratios, each indicating a likelihood that the time-series image data belong to respective one of N registered classes (where N is a natural number) corresponding to the registered image data, based on the integrated feature quantity or the score;
calculate a second likelihood ratio indicating a likelihood that the time-series image data belong to an unregistered class in a case where the time-series image data are not registered in advance, based on the N first likelihood ratios; and
determine that the time-series image data belong to the registered class in a case where the first likelihood ratio reaches a predetermined threshold, and determines that the time-series image data do not belong to any registered class in a case where the second likelihood ratio reaches the predetermined threshold.

2. The information processing apparatus according to claim 1, wherein the at least one processor is configured to execute the instructions to calculate the second likelihood ratio by nonlinear processing using the N first likelihood ratios.

3. The information processing apparatus according to claim 2, wherein the nonlinear processing uses a nonlinear function.

4. The information processing apparatus according to claim 2, wherein the nonlinear processing uses a neural network.

5. The information processing apparatus according to claim 1, wherein the at least one processor is configured to execute the instructions to calculate the second likelihood ratio, based on the N first likelihood ratios calculated from a first frame of the time-series image data, and the N first likelihood ratios calculated from a second frame that is acquired before the first frame.

6. An information processing method that is executed by at least one computer, the information processing comprising:
acquiring time-series image data;
calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculating N first likelihood ratios, each indicating a likelihood that the time-series image data belong to respective one of N registered classes (where N is a natural number) corresponding to the registered image data, based on the integrated feature quantity or the score;
calculating a second likelihood ratio indicating a likelihood that the time-series image data belong to an unregistered class in a case where the time-series image data are not registered in advance, based on the N first likelihood ratios; and
determining that the time-series image data belong to the registered class in a case where the first likelihood ratio reaches a predetermined threshold, and determining that the time-series image data do not belong to any registered class in a case where the second likelihood ratio reaches the predetermined threshold.

7. A non-transitory recording medium on which a computer program that allows at least one computer to execute an information processing method is recorded, the information processing method including:
acquiring time-series image data;
calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculating N first likelihood ratios, each indicating a likelihood that the time-series image data belong to respective one of N registered classes (where N is a natural number) corresponding to the registered image data, based on the integrated feature quantity or the score;
calculating a second likelihood ratio indicating a likelihood that the time-series image data belong to an unregistered class in a case where the time-series image data are not registered in advance, based on the N first likelihood ratios; and
determining that the time-series image data belong to the registered class in a case where the first likelihood ratio reaches a predetermined threshold, and determining that the time-series image data do not belong to any registered class in a case where the second likelihood ratio reaches the predetermined threshold.
